(19) United States
(12) Patent Application Publication
(10) Pub. No.: US 2006/0232184 A1
(43) Pub. Date: Oct. 19, 2006

(54) Flat fluorescent lamp and a display device having the same

(75) Inventors: Hae-Il Park, Seoul (KR); In-Sun Hwang, Suwon-si (KR); Sang-Yu Lee, Yongin-si (KR); Seock-Hwan Kang, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/404,960

(22) Filed: Apr. 14, 2006

(30) Foreign Application Priority Data
Apr. 15, 2005 (KR) 10-2005-0031228

(51) Int. Cl. H01J 1/62

(52) U.S. Cl. 313/489

(57) ABSTRACT

A flat fluorescent lamp and a liquid crystal display apparatus having the flat fluorescent lamp are provided. The flat fluorescent lamp includes a lamp body having first and second substrates that face each other and discharge spaces that are formed therebetween, and a protective member that is formed on an inner surface of at least one of the first or second substrates, wherein the protective member includes a cesium compound.

### CROSS-REFERENCE TO RELATED APPLICATION

The present application claims priority to Korean Patent Application No. 2005-0031228, filed on Apr. 15, 2005, the disclosure of which is incorporated by reference herein in its entirety.

### BACKGROUND OF THE INVENTION

1. Technical Field

The present invention relates to a flat fluorescent lamp and a liquid crystal display (LCD) apparatus having the flat fluorescent lamp.

2. Discussion of the Related Art

A liquid crystal display (LCD) apparatus, which is a type of flat panel display apparatus, displays an image by using liquid crystals. Liquid crystal display apparatuses have various desirable characteristics, such as small size, light weight, low driving voltage, low power consumption, etc. and are thus widely used in various electronic devices.

Since a liquid crystal display panel of the liquid crystal display apparatus is a non-emissive device that does not emit light on its own to display an image, the liquid crystal display apparatus requires a separate light source for supplying light to the liquid crystal display panel. Conventionally, a cold cathode fluorescent lamp having a long thin cylindrical or tubular shape has been used as the light source. However, in a large-sized liquid crystal display apparatus, the number of cold cathode fluorescent lamps increases, thereby optical characteristics such as brightness uniformity, etc. are deteriorated and the manufacturing cost thereof is higher.

Recently, to enhance the brightness uniformity and reduce the manufacturing cost, a flat fluorescent lamp for directly emitting light with a surface light source has been developed. The flat fluorescent lamp includes a lamp body that is partitioned into a plurality of discharge spaces to generate light, and an external electrode for applying a discharge voltage to the lamp body. In each of the discharge spaces, a plasma discharge is generated by the discharge voltage applied through the external electrode from an inverter. A fluorescent layer disposed at an inner portion of the lamp body is excited by ultra-violet light generated from the plasma discharge to generate visible light.

To implement such a flat fluorescent lamp, various coating techniques have been developed so that the electrode unit emits a large number of electrons to reduce the power consumption thereof, and so that the light emitting unit consumes most of the power during excitation and ionization.

For example, in one technique, a fluorescent oxide powder is used as a coating material. However, when the coating material is sputtered, the voltage thereof may increase as rapidly as the voltage of a non-coated electrode unit due to an impact of ions on the oxide-coated electrode unit. Therefore, there is a need for a flat florescent lamp coated with an oxide layer that is capable of increasing a lifetime of the lamp and that has high secondary ion emission efficiency.

### SUMMARY OF THE INVENTION

According to an aspect of the present invention, there is provided a flat fluorescent lamp comprising: a lamp body having first and second substrates that face each other with discharge spaces formed therebetween; and a protective member that is formed on an inner surface of at least one of the first or second substrates, wherein the protective member includes a cesium compound. The cesium compound is one of Cs—O, Ag—O—Cs, Sb—Cs, or Ag—Sb—Cs.

The flat fluorescent lamp further comprises a first electrode formed on the first substrate and a second electrode formed on the second substrate. The second substrate comprises: top portions that are separated from the first substrate to form the discharge spaces; and boundary portions that are interposed between the top portions and are adjacent to the first substrate to partition the discharge spaces. The second substrate further comprises: connection pipes for connecting adjacent discharge spaces; and an attachment portion formed along a periphery of the second substrate.

The flat fluorescent lamp further comprises: first and second fluorescent layers that are disposed on the inner surfaces of the first and second substrates, respectively; and a reflective layer that is interposed between the first substrate and the first fluorescent layer. The protective member includes an adhesive material for adhering the first substrate to the second substrate. The adhesive material is a frit.

According to another aspect of the present invention, there is provided a display apparatus comprising: a flat fluorescent lamp comprising a lamp body having first and second substrates that face each other with discharge spaces formed therebetween, and a protective member that is formed on an inner surface of at least one of the first or second substrates, wherein the protective member includes a cesium compound; an inverter for applying a discharge voltage to the flat fluorescent lamp; and a display panel for displaying an image by using light emitted from the flat fluorescent lamp. The cesium compound is one of Cs—O, Ag—O—Cs, Sb—Cs, or Ag—Sb—Cs.

The display apparatus further comprises a first electrode formed on the first substrate and a second electrode formed on the second substrate. The second substrate comprises: top portions that are separated from the first substrate to form the discharge spaces; and boundary portions that are interposed between the top portions and are adjacent to the first substrate to partition the discharge spaces. The second substrate further comprises: connection pipes for connecting adjacent discharge spaces; and an attachment portion formed along a periphery of the second substrate.

The display apparatus further comprises: first and second fluorescent layers that are disposed on the inner surfaces of the first and second substrates, respectively; and a reflective layer that is interposed between the first substrate and the first fluorescent layer. The protective member includes an adhesive material for adhering the first substrate to the second substrate. The adhesive material is a frit.

The display apparatus further comprises: a diffuser plate that is disposed on an upper portion of the flat fluorescent lamp to diffuse the light emitted from the flat fluorescent lamp; and at least one optical sheet that is disposed on an upper portion of the diffuser plate. The display apparatus also comprises: a container for accommodating the flat fluorescent lamp; a buffer member that is interposed between the container and the flat fluorescent lamp to support the flat fluorescent lamp; a first support portion for fixing the flat fluorescent lamp and supporting the diffuser plate; and a second support portion for fixing the diffuser plate and the optical sheet and supporting the display panel.

The display apparatus further comprises a top sash that is combined with the container to fix a periphery of the display panel. The display panel includes a liquid crystal layer. The display panel is included in a display unit. The discharge voltage is applied to the flat fluorescent lamp via power lines.

### BRIEF DESCRIPTION OF THE DRAWINGS

The above and other features of the present invention will become more apparent by describing in detail exemplary embodiments thereof with reference to the attached drawings, in which:

FIG. 1 is a perspective view showing a flat fluorescent lamp according to an exemplary embodiment of the present invention;

FIGS. 2A and 2B are cross-sectional views showing the flat fluorescent lamp taken along lines IIa-IIa and IIb-IIb of FIG. 1, respectively;

FIG. 3 is a graph showing changes in discharge sustain voltages;

FIG. 4 is a table showing secondary electron emission coefficients of various oxides;

FIG. 5 is a graph showing a temperature distribution of both end portions of an electrode; and

FIG. 6 is an exploded perspective view showing a liquid crystal display apparatus according to an exemplary embodiment of the present invention.

### DETAILED DESCRIPTION OF EXEMPLARY EMBODIMENTS

Hereinafter, exemplary embodiments of the present invention will be described with reference to the accompanying drawings.

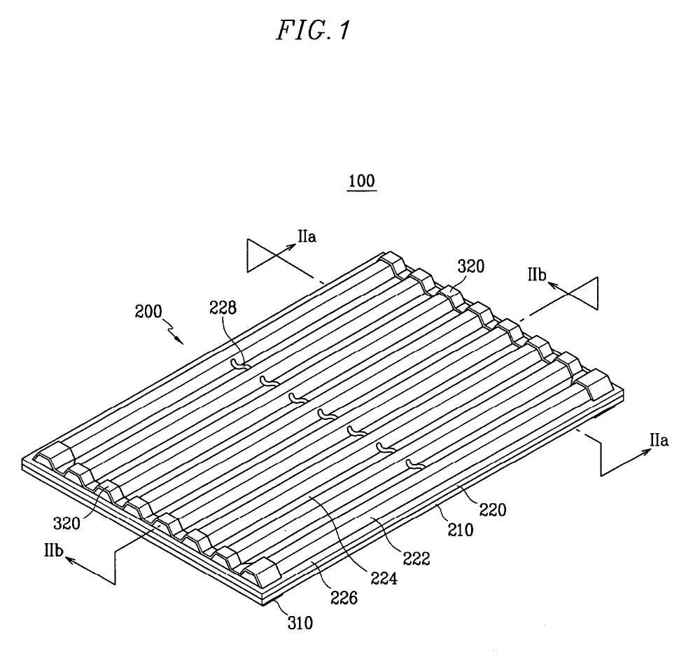

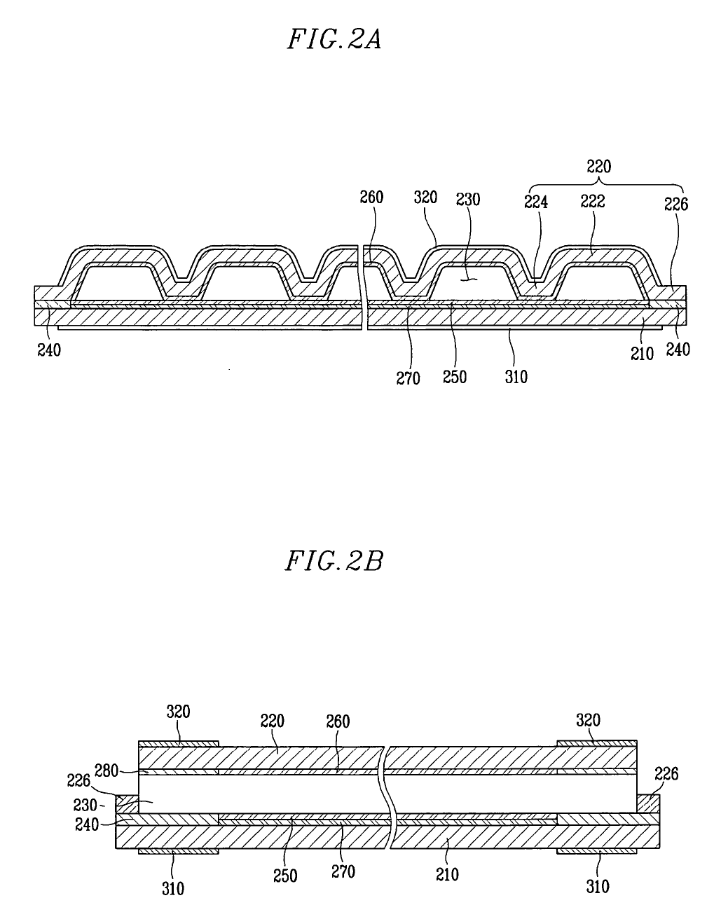

FIG. 1 is a perspective view showing a flat fluorescent lamp according to an embodiment of the present invention, and FIGS. 2A and 2B are cross-sectional views showing the flat fluorescent lamp taken along lines IIa-IIa and IIb-IIb of FIG. 1, respectively.

Referring to FIGS. 1, 2A, and 2B, a flat fluorescent lamp 100 includes a lamp body 200, lower electrodes 310 disposed along both end portions of a lower surface of the lamp body 200, and upper electrodes 320 disposed along both end portions of an upper surface of the lamp body 200.

The lamp body 200 has a substantially rectangular shape. The lamp body 200 includes lower and upper substrates 210 and 220 that face each other, lower and upper fluorescent layers 250 and 260 that are coated on portions of inner surfaces of the lower and upper substrates 210 and 220, a reflective layer 270 that is interposed between the lower substrate 210 and the lower fluorescent layer 250, and adhesive-protective members 240 and 280 that are coated on edge portions of the inner surfaces of the lower and upper substrates 210 and 220.

The lower and upper substrates 210 and 220 are made of transparent glass. In addition, the lower and upper substrates 210 and 220 may include a material that is capable of shielding ultra-violet light.

The lower substrate 210 has a substantially rectangular shape. The upper substrate 220 has a corrugated shape in one direction to form a plurality of discharge spaces 230 between the lower and upper substrates 210 and 220, extending in a direction parallel to the corrugations. The discharge spaces 230 are filled with a discharge gas for generating a plasma discharge. Examples of the discharge gas may include mercury (Hg), neon (Ne), argon (Ar), and the like.

As further shown in FIGS. 1, 2A and 2B, the upper substrate 220 includes top portions 222, boundary portions 224, an attachment portion 226, and connection pipes 228.

Each of the top portions 222 has a cross-sectional shape of an arch with a flat top or a trapezoid that is erected on the lower substrate 210 to form a top surface and side walls of the discharge space 230. Alternatively, each of the top portions 222 may have a cross-sectional shape of a semi-circle, a rectangle, or other various shapes.

The boundary portions 224 are interposed between the top portions 222 and are adjacent to the lower substrate 210 to partition the discharge spaces 230. The boundary portions 224 can be hermetically sealed to the lower substrate 210 due to a difference between internal and external pressures of the discharge spaces 230. For example, a pressure of the discharge gas filling the discharge spaces 230 is in a range of about 50 torr to about 70 torr, which is below the atmospheric pressure of about 760 torr. Due to the difference between the internal and external pressures, forces are applied to the lamp body 200 and the boundary portions 224 can be hermetically sealed to the lower substrate 210.

The connection pipes 228 connect adjacent discharge spaces 230, and serve as paths for passing air and the discharge gas when venting the air and injecting the discharge gas into the discharge spaces 230. Although the connection pipes 228 have an S-shape as shown in FIG. 1, the connection pipes 228 may have various other shapes. Since the connection pipes 228 have the S-shape as shown in FIG. 1, a distance between the adjacent discharge spaces 230 can change with the occurrence of a drift phenomenon without causing disconnection of the connection pipe 228.

The attachment portion 226 is formed along the periphery of the upper substrate 220.

The upper substrate 220 having the above-described shape may be formed by a molding process. For example, a rectangular glass plate is heated to a predetermined temperature, and is then molded with a template having a desired shape to form the upper substrate 220. Alternatively, a glass plate is heated, and then air is injected therein to form the upper substrate 220 having the desired shape. Various other methods may also be used to form the upper substrate 220.

The adhesive-protective members 240 and 280 are made of a mixture of an adhesive material and a cesium (Cs) compound. As a preferred adhesive material, a frit, which is a mixture of glass and a metal that has a lower melting point than the glass, may be used. The cesium compound has a high secondary electron emission coefficient, and it may be one of Cs—O, Ag—O—Cs, Sb—Cs, or Ag—Sb—Cs. The adhesive-protective members 240 are disposed between an upper portion of the lower substrate 210 corresponding to the lower electrodes 310 and a lower portion of the attachment portion 226 of the upper substrate 220, so that the adhesive-protective members 240 can contact the lower and upper substrates 210 and 220. In an adhering process, the adhesive-protective members 280 are disposed on a lower portion of the upper substrate 220 corresponding to the upper electrodes 320. The adhesive-protective members 240 and 280 are melted by externally-applied heat, and then cured to adhere the lower substrate 210 to the upper substrate 220. The adhering process is performed in a temperature range of about 400 degrees to about 600 degrees.

The lower and upper fluorescent layers 250 and 260 and the reflective layer 270 are coated as thin layers on some regions of the inner surfaces of the lower and upper substrates 210 and 220 where the adhesive-protective members 240 and 280 are not disposed. The reflective layer 270 may include a metal oxide such as aluminum oxide (Al₂O₃) or barium sulfate (BaSO₄).

The lower and upper fluorescent layers 250 and 260 and the reflective layer 270 are coated with a spraying method; they may not be coated on the regions corresponding to the boundary portions 224.

The lamp body 200 may further include a protective layer (not shown) that is formed between the lower substrate 210 and the reflective layer 270 and/or between the upper substrate 220 and the upper fluorescent layer 260.

The lower and upper electrodes 310 and 320 extend in a direction that intersects the discharge spaces 230. The lower and upper electrodes 310 and 320 may be made of a silver paste, in other words, a mixture of silver (Ag) and silicon oxide (SiO₂). Alternatively, the lower and upper electrodes 310 and 320 may be formed with a spray-coating process by spraying a metal powder made of a metal or a metal mixture.

Hereinafter, operations of the flat fluorescent lamp 100 will be described in detail.

When an inverter (not shown) that is located outside of the flat fluorescent lamp 100 applies a discharge voltage to the lower and upper electrodes 310 and 320, a plasma discharge is generated in the discharge spaces 230 to generate ultra-violet light. The lower and upper fluorescent layers 250 and 260 are excited by the ultra-violet light such that they emit visible light. The visible light emits through the transparent upper substrate 220. Since the lamp body 200 has a wide emission area, the emission efficiency thereof is high. In addition, since an inner space is partitioned into a large number of discharge spaces 230, uniform discharge can be obtained.

The reflective layer 270 reflects the visible light to prevent it from leaking through the lower substrate 210. In addition, the oxide material included in the reflective layer 270 increases reflectance and reduces a change in color coordinates, and the ultra-violet light shielding material included in the lower and upper substrates 210 and 220 prevents the ultra-violet light generated by the plasma discharge from leaking.

The protective layer prevents the lower and upper substrates 210 and 220 from chemically reacting with mercury (Hg), which is a main component of the discharge gas, so that a loss of mercury and a blackening phenomenon can be prevented.

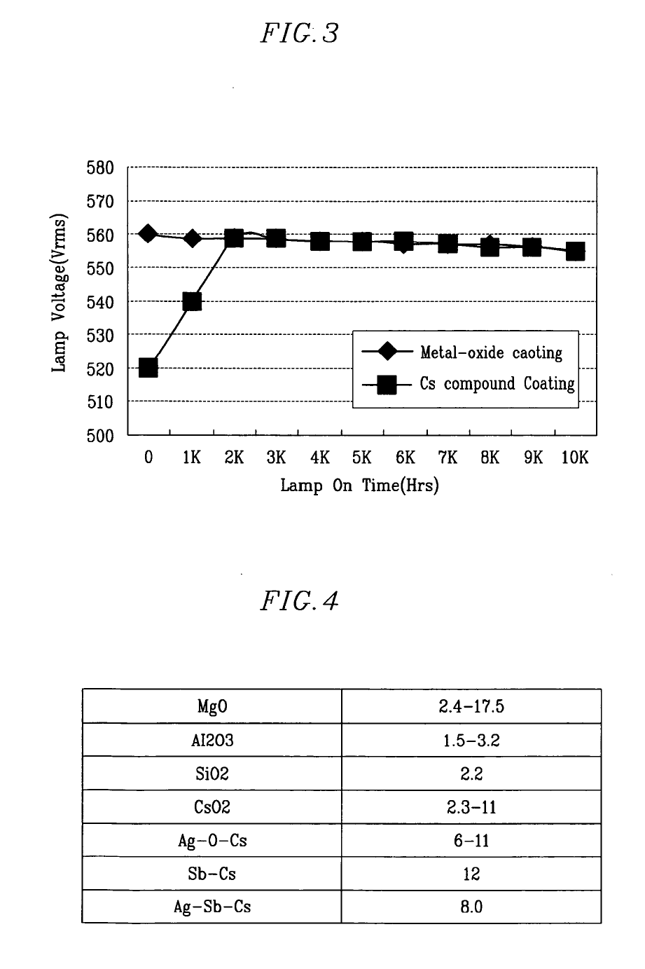

FIG. 3 is a graph showing changes in discharge sustain voltages in a flat fluorescent lamp according to an embodiment of the present invention wherein the frit and the cesium component are coated, and in a conventional flat fluorescent lamp wherein a metal oxide is coated.

The flat fluorescent lamp wherein the metal oxide is coated has a discharge sustain voltage that is substantially equal to that of a flat fluorescent lamp wherein the metal oxide is not coated (not shown). This is because the metal oxide is stripped from the lower portions of the lower and upper electrodes 310 and 320 by an impact of ions of the plasma discharge.

However, it can be seen in FIG. 3, that in the flat fluorescent lamp wherein the frit and the cesium compound are coated, the discharge sustain voltage gradually increases. It is postulated that this is because the cesium compound is strongly bonded to the frit. In addition, when the ions of the plasma discharge impact, the cesium compound that has a higher secondary electron emission coefficient than general oxide materials emits electrons in advance to protect the frit.

FIG. 4 is a table showing secondary electron emission coefficients of various oxides.

As shown in FIG. 4, the cesium compound has a higher secondary electron emission coefficient than other oxides. Magnesium oxide (MgO) also has a high secondary electron emission coefficient, but since the magnesium oxide is exposed to the ambient atmosphere the emission efficiency thereof rapidly decreases, thus it is not efficacious to use as a material for the flat fluorescent lamp. In addition, unlike a plasma display panel (PDP) apparatus, the lifetime of the general flat fluorescent lamp at a low pressure of several tens of torr is shortened due to severe ion sputtering.

In the flat fluorescent lamp according to an embodiment of the present invention, however, the loss of layers caused by the sputtering is prevented by using the cesium compound, so that the lifetime thereof can be increased. In addition, by using a large number of the secondary electrons generated from the cesium compound, the emission efficiency of the flat fluorescent lamp is improved.

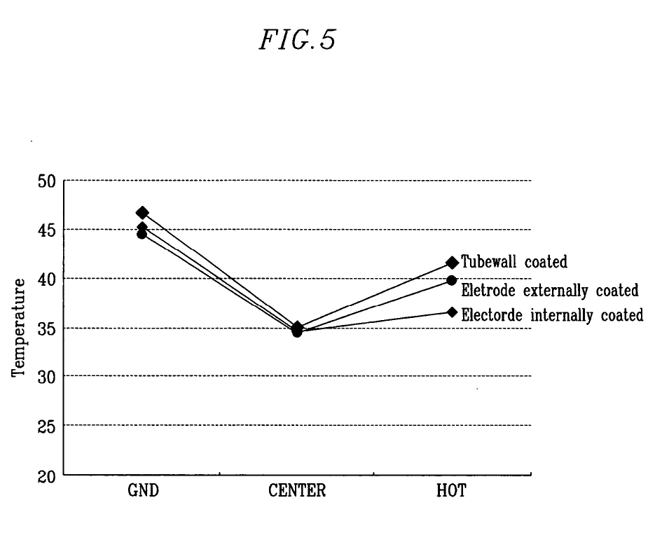

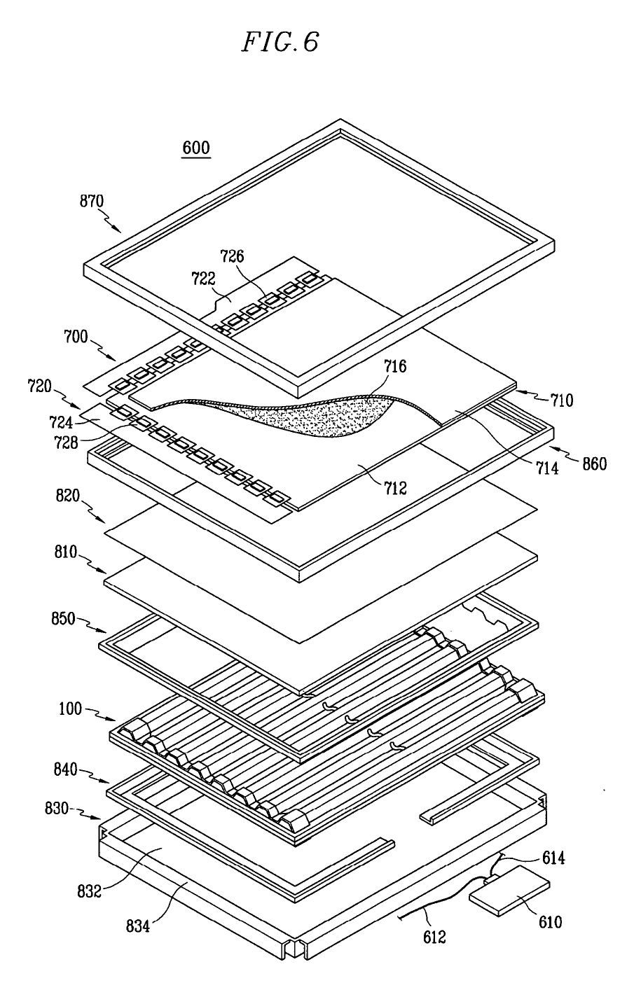

FIG. 5 is a graph showing a temperature distribution of both end portions of an electrode, for example, one of the lower or upper electrodes 310 and 320.

Here, one end portion (GND) of the electrode is not coated with the cesium compound, and the other end portion (HOT) is coated with the cesium compound. The temperature distribution shown in FIG. 5 results from a reduction in a heat-increasing effect caused by the impact of ions as a tube voltage of the cesium-compound-coated portion decreases. Therefore, as the emission efficiency increases, the temperature of the electrode decreases, thus the growth of the frit can be suppressed.

FIG. 6 is an exploded perspective view showing a liquid crystal display apparatus according to an embodiment of the present invention.

Referring to FIG. 6, the liquid crystal display apparatus 600 includes a flat fluorescent lamp 100 for generating light, an inverter 610 for applying a discharge voltage to the flat fluorescent lamp 100, and a display unit 700 for displaying an image.

Since the flat fluorescent lamp 100 may have a structure and function that is the same as or similar to the embodiments of the present invention shown and described above with reference to FIGS. 1 to 5, like reference numerals denote like elements, and descriptions of the same components are omitted.

The inverter 610 boosts an externally-applied AC voltage having a low level to a high level AC voltage to light the flat fluorescent lamp 100, and generates the discharge voltage. The discharge voltage generated by the inverter 610 is applied through first and second power supply lines 612 and 614 to the lower electrodes 310 and the upper electrodes 320 of the flat fluorescent lamp 100, respectively. For example, the lower electrodes 310 and the upper electrodes 320 are connected to an electrical plug (not shown), and the first and second power supply lines 612 and 614 are connected to the lower electrodes 310 and the upper electrodes 320 through the electrical plug.

The display unit 700 includes a liquid crystal display panel 710 for displaying an image by using light emitted from the flat fluorescent lamp 100, and a circuit driving portion 720 for driving the liquid crystal display panel 710.

The liquid crystal display panel 710 includes first and second substrates 712 and 714 that face each other, and a liquid crystal layer 716 that is interposed therebetween.

The first substrate 712 is a thin film transistor (TFT) substrate on which TFTs, which are used as switching devices, are arranged in a matrix. For example, the first substrate 712 is made of glass. Source and gate terminals of each of the TFTs are connected to data and gate lines of the first substrate 712, respectively, and a drain terminal thereof is connected to a pixel electrode that is made of a transparent conductive material.

The second substrate 714 is a color filter substrate on which red, green, and blue (RGB) pixels for forming colors are formed in a thin film shape. For example, the second substrate 714 is made of glass. A common electrode made of a transparent conductive material is disposed on the second substrate 714.

In the liquid crystal display panel 710, when power is supplied to the gate terminal of one of the TFTs to turn the TFT on, an electric field is generated between the pixel electrode and the common electrode. Due to the electric field, the alignment of liquid crystal molecules in the liquid crystal layer 716 changes and transmittance of light emitted from the flat fluorescent lamp 100 changes according to the alignment of the liquid crystal molecules, so that an image with a desired grayscale can be displayed.

The driving circuit portion 720 includes a data printed circuit board 722 for supplying data driving signals to the liquid crystal display panel 710, a gate printed circuit board 724 for supplying gate driving signals to the liquid crystal display panel 710, a data flexible circuit film 726 for connecting the data printed circuit board 722 to the liquid crystal display panel 710, and a gate flexible circuit film 728 for connecting the gate printed circuit board 724 to the liquid crystal display panel 710. The data and gate flexible circuit films 726 and 728 may be configured as a tape carrier package (TCP) or a chip-on film (COF).

The data printed circuit board 722 may be disposed on a side or rear surface of a container 830 for accommodating the flat fluorescent lamp 100, as the data flexible circuit film 726 is pliant. The gate printed circuit board 724 may be disposed on the side or rear surface of the container 830, as the gate flexible circuit film 728 is also pliant. Alternatively, the gate printed circuit board 724 may be omitted by disposing signal wire lines on the liquid crystal display panel 710 and the gate flexible circuit film 728.

The liquid crystal display apparatus 600 may further comprise a diffuser plate 810 that is disposed on an upper portion of the flat fluorescent lamp 100 to diffuse the light emitted from the flat fluorescent lamp 100, and at least one optical sheet 820 that is disposed on an upper portion of the diffuser plate 810.

The diffuser plate 810 improves brightness uniformity of the light by diffusing the light emitted from the flat fluorescent lamp 100. The diffuser plate 810 is constructed in a plate shape having a predetermined thickness, and is disposed to be separated by a predetermined distance from the flat fluorescent lamp 100. The diffuser plate 810 is made of a transparent material for transmitting light and a diffusing agent for diffusing the light. For example, the diffuser plate 810 may be made of polymethyl methacrylate (PMMA).

The optical sheet 820 improves the brightness characteristic by changing paths of the light diffused by the diffuser plate 810. The optical sheet 820 may include a condensing sheet for improving front brightness by condensing the light diffused by the diffuser plate 810 in the front direction thereof. In addition, the optical sheet 820 may include an additional diffuser sheet for further diffusing the light diffused by the diffuser plate 810. Moreover, depending on a required brightness characteristic, optical sheets for enhancing brightness may be added to the liquid crystal display apparatus 600.

The container 830 for accommodating the flat fluorescent lamp 100 is made of a metal having high strength and a low degree of deformation, and is constructed with a bottom portion 832 and side portions 834 which extend from edges of the bottom portion 832 to form an accommodation space. For example, the side portions 834 may have a two-step-bent structure for providing a space to which other components are engaged and to increase the engaging force therebetween.

The liquid crystal display apparatus 600 may further include a buffer member 840 that is disposed between the flat fluorescent lamp 100 and the container 830 to support the flat fluorescent lamp 100. For example, the buffer member 840 is disposed along the edge of the flat fluorescent lamp 100 to separate the flat fluorescent lamp 100 from the container 830 by a predetermined distance to electrically disconnect the flat fluorescent lamp 100 from the container 830 that is made of a metal. For this reason, the buffer member 840 is made of an insulating material. In addition, it is preferable that the buffer member 840 is made of an elastic material to absorb external impacts. For example, the buffer member 840 may be made of a silicon-based material. The buffer member 840 is constructed with two Π/U-shaped pieces. Alternatively, the buffer member 840 may be constructed with four bar-shaped pieces corresponding to the four sides of the flat fluorescent lamp 100. As a further alternative, the buffer member 840 may be constructed with four bent pieces corresponding to the four corners of the flat fluorescent lamp 100. Otherwise, the buffer member 840 may be constructed as one frame in an integral manner.

The liquid crystal display apparatus 600 may further include a first support portion 850 that is disposed between the flat fluorescent lamp 100 and the diffuser plate 810. The first support portion 850 supports the peripheries of the flat fluorescent lamp 100 and the diffuser plate 810. As shown in FIG. 6, the first support portion 850 is constructed as one frame in an integral manner. Alternatively, the first support portion 850 may be constructed with two Π/U-shaped or L-shaped pieces. Otherwise, the first support portion 850 may be constructed with four partitioned bar-shaped pieces corresponding to the four sides of the flat fluorescent lamp 100 or the diffuser plate 810.

The liquid crystal display apparatus 600 may further include a second support portion 860, interposed between the optical sheet 820 and the liquid crystal display panel 710. The second support portion 860 fixes peripheries of the optical sheet 820 and the diffuser plate 810 and fixes a periphery of the liquid crystal display panel 710. Similar to the first support portion 850, the second mold 860 may have an integrally-formed frame or a divided structure of two or four pieces.

The liquid crystal display apparatus 600 may further include a top sash 870 for fixing the display unit 700. The top sash 870 is combined with the container 830 to fix the periphery of the liquid crystal display panel 710. Here, the data printed circuit board 722 is affixed on a side portion or a top portion of the container 830, as the data flexible circuit film 726 is pliant. For example, the top sash 870 is made of a metal having a low degree of deformation and high strength.

In a flat fluorescent lamp and a liquid crystal display apparatus having the flat fluorescent lamp according to an embodiment of the present invention, since an adhesive member for adhering a lower substrate to an upper substrate of the flat fluorescent lamp includes a cesium compound, start-up and sustain voltages of the lamp can be reduced, thereby increasing emission efficiency of the lamp. In addition, a temperature of electrode units can be reduced, thereby suppressing frit growth in the electrode units. Further, since the loss of layers caused by sputtering is prevented by using the cesium compound, the lifetime of the lamp can be increased.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

What is claimed is:

1. A flat fluorescent lamp comprising:
a lamp body having first and second substrates that face each other with discharge spaces formed therebetween; and
a protective member that is formed on an inner surface of at least one of the first or second substrates,
wherein the protective member includes a cesium compound.

2. The flat fluorescent lamp of claim 1, wherein the cesium compound is one of Cs—O, Ag—O—Cs, Sb—Cs, or Ag—Sb—Cs.

3. The flat fluorescent lamp of claim 1, further comprising a first electrode formed on the first substrate.

4. The flat fluorescent lamp of claim 3, further comprising a second electrode formed on the second substrate.

5. The flat fluorescent lamp of claim 4, wherein the second substrate comprises: top portions that are separated from the first substrate to form the discharge spaces; and
boundary portions that are interposed between the top portions and are adjacent to the first substrate to partition the discharge spaces.

6. The flat fluorescent lamp of claim 5, wherein the second substrate further comprises:
connection pipes for connecting adjacent discharge spaces; and
an attachment portion formed along a periphery of the second substrate.

7. The flat fluorescent lamp of claim 1, further comprising:
first and second fluorescent layers that are disposed on the inner surfaces of the first and second substrates, respectively; and
a reflective layer that is interposed between the first substrate and the first fluorescent layer.

8. The flat fluorescent lamp of claim 1, wherein the protective member includes an adhesive material for adhering the first substrate to the second substrate.

9. The flat fluorescent lap of claim 8, wherein the adhesive material is a frit.

10. A display apparatus comprising:
a flat fluorescent lamp comprising a lamp body having first and second substrates that face each other with discharge spaces formed therebetween, and a protective member that is formed on an inner surface of at least one of the first or second substrates, wherein the protective member includes a cesium compound;
an inverter for applying a discharge voltage to the flat fluorescent lamp; and
a display panel for displaying an image by using light emitted from the flat fluorescent lamp.

11. The display apparatus of claim 10, wherein the cesium compound is one of Cs—O, Ag—O—Cs, Sb—Cs, or Ag—Sb—Cs.

12. The display apparatus of claim 10, further comprising a first electrode formed on the first substrate.

13. The display apparatus of claim 12, further comprising a second electrode formed on the second substrate

14. The display apparatus of claim 13, wherein the second substrate comprises:
top portions that are separated from the first substrate to form the discharge spaces; and
boundary portions that are interposed between the top portions and are adjacent to the first substrate to partition the discharge spaces.

15. The display apparatus of claim 14, wherein the second substrate further comprises:
connection pipes for connecting adjacent discharge spaces; and
an attachment portion formed along a periphery of the second substrate.

16. The display apparatus of claim 10, further comprising:
first and second fluorescent layers that are disposed on the inner surfaces of the first and second substrates, respectively; and
a reflective layer that is interposed between the first substrate and the first fluorescent layer.

17. The display apparatus of claim 10, wherein the protective member includes an adhesive material for adhering the first substrate to the second substrate.

18. The display apparatus of claim 17, wherein the adhesive material is a frit.

19. The display apparatus of claim 10, further comprising:
a diffuser plate that is disposed on an upper portion of the flat fluorescent lamp to diffuse the light emitted from the flat fluorescent lamp; and
at least one optical sheet that is disposed on an upper portion of the diffuser plate.

20. The display apparatus of claim 19, further comprising:
a container for accommodating the flat fluorescent lamp;
a buffer member that is interposed between the container and the flat fluorescent lamp to support the flat fluorescent lamp;
a first support portion for fixing the flat fluorescent lamp and supporting the diffuser plate; and
a second support portion for fixing the diffuser plate and the optical sheet and supporting the display panel.

21. The display apparatus of claim 20, further comprising:
a top sash that is combined with the container to fix a periphery of the display panel.

22. The display apparatus of claim 20, wherein the display panel includes a liquid crystal layer.

23. The display apparatus of claim 22, wherein the display panel is included in a display unit.

24. The display apparatus of claim 10, wherein the discharge voltage is applied to the flat fluorescent lamp via power lines.
